(19) United States
(12) Patent Application Publication
(10) Pub. No.: US 2024/0047738 A1
(43) Pub. Date: Feb. 8, 2024

(54) SULFIDE-BASED SOLID ELECTROLYTE

(71) Applicant: HONDA MOTOR CO., LTD., Tokyo (JP)

(72) Inventors: Rio KOYAMA, Saitama (JP); Satoshi YONEZAWA, Saitama (JP); Masaki KUNIGAMI, Saitama (JP)

(21) Appl. No.: 18/366,632

(22) Filed: Aug. 7, 2023

(30) Foreign Application Priority Data
Aug. 8, 2022 (JP) 2022-126120

(51) Int. Cl. H01M 10/0562; H01M 10/0585; H01M 4/38

(52) U.S. Cl. CPC H01M 10/0562; H01M 10/0585; H01M 4/382; H01M 2300/0068; H01M 2004/027

(57) ABSTRACT

A sulfide-based solid electrolyte is provided which is superior in oxidation resistance and reduction resistance. A sulfide-based solid electrolyte includes a chemical bond formed between Li₂S—P₂S₅ and LiBH₄, in which a mole ratio of the Li₂S—P₂S₅ and the LiBH₄ is 1:0.5.

This application is based on and claims the benefit of priority from Japanese Patent Application No. 2022-126120, filed on 8 Aug. 2022, the content of which is incorporated herein by reference.

### BACKGROUND OF THE INVENTION

### Field of the Invention

The present invention relates to a sulfide-based solid electrolyte.

### Related Art

In recent years, research and development related to secondary batteries that contribute to energy efficiency has been conducted in order to make it possible to ensure access to more people of affordable, reliable, sustainable and advanced energy. Among secondary batteries, the solid-state battery is superior in the point of the stability improving due to the solid electrolyte used as the conductor of charge transfer medium such as lithium ion being nonflammable, and the point of having higher energy density, and thus has received particular attention.

As a solid electrolyte, a sulfide-based solid electrolyte having high lithium-ion conductivity has been known conventionally (for example, refer to Patent Document 1).
Patent Document 1: PCT International Publication No. WO2020/050269

### SUMMARY OF THE INVENTION

The sulfide-based solid electrolyte disclosed in Patent Document 1 has an issue in the reduction resistance to lithium metal in the case of using lithium metal as the negative electrode of a solid-state battery. When the solid electrolyte is reduced, for example, a resistive layer is formed from Li₂S, etc. In addition, a sulfide-based solid electrolyte has an issue in oxidation resistance to a high-potential active material. When the solid electrolyte is oxidized, resistance increases due to an oxidized film.

The present invention has been made taking account of the above, and has an object of providing a sulfide-based solid electrolyte superior in oxidation resistance and reduction resistance.

A first aspect of the present invention is related to a sulfide-based solid electrolyte that includes a chemical bond between Li₂S—P₂S₅ and LiBH₄, in which a mole ratio of the Li₂S—P₂S₅ and the LiBH₄ is 1:0.5.

According to the first aspect of the present invention, it is possible to provide a sulfide-based solid electrolyte superior in oxidation resistance and reduction resistance.

According to a second aspect of the present invention, a solid-state secondary battery includes a laminate body wherein a positive electrode layer, solid electrolyte layer and negative electrode layer are laminated, in which at least any of the positive electrode layer, the solid electrolyte layer and the negative electrode layer has the sulfide-based solid electrolyte as described in the first aspect, and the negative electrode layer has a lithium metal layer.

According to the second aspect of the present invention, due to the solid electrolyte having superior reduction resistance in the solid-state secondary battery having a lithium metal layer as the negative electrode layer, it is possible to improve the durability of the solid-state secondary battery.

According to a third aspect of the present invention, a method of manufacturing the sulfide-based solid electrolyte as described in the first aspect includes a step of preparing by a liquid phase method so that a mole ratio of Li₂S, P₂S₅ and LiBH₄ becomes 6:2:3.

According to the third aspect of the present invention, it is possible to preferably manufacture the sulfide-based solid electrolyte as described in the first aspect.

### BRIEF DESCRIPTION OF THE DRAWINGS

FIG. 1 is the XRD spectra of the sulfide-based solid electrolytes related to the Examples and Comparative Examples;

FIG. 2 is a graph showing charge/discharge test results of a sulfide-based solid electrolyte according to Examples;

FIG. 3 is a graph showing charge/discharge test results of a sulfide-based solid electrolyte according to Examples;

FIG. 4 is a graph showing a relationship between a heat treatment time and ionic conductivity of a sulfide-based solid electrolyte according to Examples;

FIG. 5 provides LSV measurement results of sulfide-based solid electrolytes related to the Examples and Comparative Examples; and

FIG. 6 is a graph of durability test results of a sulfide-based solid electrolyte according to Examples.

### DETAILED DESCRIPTION OF THE INVENTION

### <Sulfide-based Solid Electrolyte>

The sulfide-based solid electrolyte according to the present embodiment is superior in both reduction resistance and oxidation resistance than a conventional sulfide-based solid electrolyte. Therefore, the sulfide-based solid electrolyte according to the present embodiment can be preferably applied to a solid-state secondary battery made by configuring a negative electrode with a material of relative low potential such as lithium metal, for example.

In the sulfide-based solid electrolyte according to the present embodiment, a chemical bond is formed between Li₂S—P₂S₅ and LiBH₄, and the mole ratio of Li₂S—P₂S₅ to LiBH₄ is 1:0.5. In the XRD spectra obtained by XRD measurement, the sulfide-based solid electrolyte according to the present embodiment has a novel crystalline structure having crystal peaks in the vicinity of 2θ[deg]=29, 33, 48, and 57, and the formation of the above-mentioned chemical bonds are presumed.

In the sulfide-based solid electrolyte according to the present embodiment, due to BH⁴⁻ which is a complex ion existing, reduction resistance can be consider to improve relative to the negative electrode configured from a relatively low potential material such as lithium metal.

### <Method of Manufacturing Sulfide-based Solid Electrolyte>

The method of manufacturing the sulfide-based solid electrolyte according to the present embodiment includes a step of preparing by a liquid phase method so that the mole ratio of Li₂S, P₂S₅ and LiBH₄, Li₂S:P₂S₅:LiBH₄ becomes 6:2:3. The step of preparing by the above liquid phase method includes a stirring step of blending the Li₂S, P₂S₅ and LiBH₄ so that the mole ratio becomes 6:2:3, and stirring in solvent such as THF, and a solvent removal step of removing the solvent by heating while continuing stirring. Other than the above, the production method of the sulfide-based solid electrolyte may include a heat treatment step. By the heat treatment step, the crystals of sulfide-based solid electrolyte are grown, whereby it is possible to improve the conductivity.

### <Solid-State Secondary Battery>

The solid-state secondary battery according to the present embodiment has a laminate body in which a positive electrode layer, solid electrolyte layer and negative electrode layer are laminated in this order. At least any of the above-mentioned positive electrode layer, solid electrolyte layer and negative electrode layer has the sulfide-based electrolyte according to the present embodiment. The above-mentioned laminate body may have an intermediate layer which suppresses non-uniform precipitation of metal on the interface of the negative electrode layer between the solid electrolyte layer and the negative electrode layer. On the other hand, since the sulfide-based solid electrolyte according to the present embodiment has superior reduction resistance, it is also possible to configure the solid-state secondary battery by the laminate body not having the above-mentioned intermediate layer. It is thereby possible to improve the energy density of the solid-state secondary battery, and possible to decrease the production cost.

### (Positive Electrode Layer)

The positive electrode layer is a layer having a positive electrode collector, and a positive electrode active material layer containing at least a positive electrode active material.

The positive electrode collector is not particularly limited so long as having a function of performing current collection of the positive electrode layer, and can be exemplified by aluminum, aluminum alloy, stainless steel, nickel, silver, titanium or the like, for example, and thereamong, aluminum, aluminum alloy and stainless steel are preferred. In addition, the shape of the positive electrode collector, for example, can be exemplified by foil, plate or the like.

The positive electrode active material contained in the positive electrode active material layer can be established as the same as that used in the positive electrode layer of a common solid-state battery, and is not particularly limited. For example, so long as a lithium ion battery, it is possible to exemplify a film-like active material containing lithium, spinel-type active material, olivine-type active material or the like. As specific examples of the positive electrode active material, lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium magnesium oxide (LiMn₂O₄), a different kind element substituted li-Mn spinel represented by Li₁₊ₓMn_{2-x-y}MyO₄ (x+y=2, M=at least one type selected from Al, Mg, Co, Fe, Ni and Zn), lithium titanate (oxide containing Li and Ti), lithium metal phosphate (LiMPO₄, M=at least one type selected from Fe, Mn, Co and Ni), etc. can be exemplified.

The positive electrode active material layer may include any solid electrolyte from the viewpoint of improving the charge transfer medium conductivity. As the above-mentioned solid electrolyte, it is preferably a sulfide-based solid electrolyte according to the present embodiment due to having oxidation resistance. In addition, the positive electrode active material layer may include any conductive auxiliary agent for improving conductivity. Furthermore, it may include any binder from the viewpoint of realizing binding force between particles. Regarding the conductive auxiliary agent and binder, it is possible to use those generally used in solid-state batteries.

### (Solid Electrolyte Layer)

The solid electrolyte layer is a layer laminated between the positive electrode layer and negative electrode layer, and is a layer containing at least the solid electrolyte material. Via the solid electrolyte material included in the solid electrolyte layer, it is possible to perform charge transfer medium conduction between the positive electrode active material and negative electrode active material. The solid electrolyte contained in the solid electrolyte layer is preferably a sulfide-based solid electrolyte according to the present embodiment.

### (Negative Electrode Layer)

The negative electrode layer is a layer made from the negative electrode collector and a negative electrode active material layer containing at least the negative electrode active material.

The negative electrode collector is not particularly limited so long as having a function of performing current collection of the negative electrode layer, and it is possible to exemplifying nickel, copper, stainless steel, etc. as the material of the negative electrode collector, for example. In addition, as the shape of the negative electrode collector, for example, it is possible to exemplify foil, plate, etc.

As the negative electrode active material contained in the negative electrode active material layer, it is possible to appropriately select and use a known material which can store and release, or dissolve and precipitate the charge transfer medium such as lithium ion. For example, a lithium transition metal oxide such as lithium titanate, transition metal oxide such as TiO₂, Nb₂O₃ and WO₃, Si, SiO, metal sulfides, metal nitrides, and carbon materials such as artificial graphite, natural graphite, graphite, soft carbon and hard carbon, and lithium metal, indium metal and lithium alloy can be exemplified. As the negative electrode active material layer, one having a lithium metal layer is preferred. Even in the case of using the Li metal layer having metal lithium, which is a relative low potential material as the negative electrode active material layer, the sulfide-based solid electrolyte according to the present embodiment can obtain preferable durability in the solid secondary battery due to having superior reduction resistance.

The negative electrode active material layer may contain any solid electrolyte from the viewpoint of improving the charge transfer medium conductivity. As the above-mentioned solid electrolyte, it is preferably the sulfide-based solid electrolyte according to the present embodiment due to having reduction resistance. In addition, it may contain any binder from the viewpoint of realizing flexibility. The binder can employ one generally used in solid-state batteries.

### <Method of Manufacturing Solid-state Secondary Battery>

The method of manufacturing a solid-state secondary battery according to the present embodiment is not particularly limited, and is manufactured by laminating in this order the above-mentioned positive electrode layer, solid electrolyte layer and negative electrode layer. It should be noted that it may be optionally integrated by pressing after the above-mentioned laminating. Further, a plurality of the above-mentioned constituent units may be laminated as a unit battery.

Although a preferred embodiment of the present invention has been explained above, the present invention is not to be limited to the above embodiment, and modifications and improvements within a scope which can achieve the object of the present invention are encompassed by the present invention.

### EXAMPLES

Hereinafter, the present invention will be explained in detail using the Examples. However, the present invention is not to be limited to these Examples.

### Preparation of Sulfide-based Solid Electrolyte

### Example 1

So that the mole ratio of Li₂S, P₂S₅ and LiBH₄ as raw materials of the sulfide-based solid electrolyte becomes 3:1:2, they are blended, stirred with 20 ml of THF as a solvent using a flask mixer (30 rpm, 25° C.) to make a uniform dispersed/dissolved state. Next, the solvent was removed by heating in a mantle heater while stirring (30 rpm, 150° C.) After solvent removal, the sulfide-based electrolyte according to Example 1 was prepared by heat treating (100° C.) in a vacuum electric furnace.

### Comparative Examples 1 and 2

Except for establishing the mole ratio of Li₂S, P₂S₅ and LiBH₄ as the ratio shown in Table 1, the sulfide-based solid electrolytes according to Comparative Examples 1 and 2 were prepared similarly to Example 1.

TABLE 1

| Examples/ | | | | Blending ratio | Solvent | Heating |
|---|---|---|---|---|---|---|
| Comparative Examples | Blending amount (g) | | | (mol ratio) | amount | temperature |
| (sample name) | Li₂S | P₂S₅ | LiBH₄ | Li₂S:P₂S₅:LiBH₄ | (mL) | (° C.) |
| Comparative Example1 | 0.1035 | 0.3269 | 0.0706 | 6:2:9 | 20 | 100 |
| (LPS-1.5LiBH₄) | | | | | | |
| Comparative Example2 | 0.1061 | 0.34 | 0.047 | 3:1:3 | 20 | 100 |
| (LPS-LiBH₄) | | | | | | |
| Example1 (LPS-0.5LiBH₄) | 0.1007 | 0.329 | 0.024 | 6:2:3 | 20 | 100 |

### (XRD Measurement)

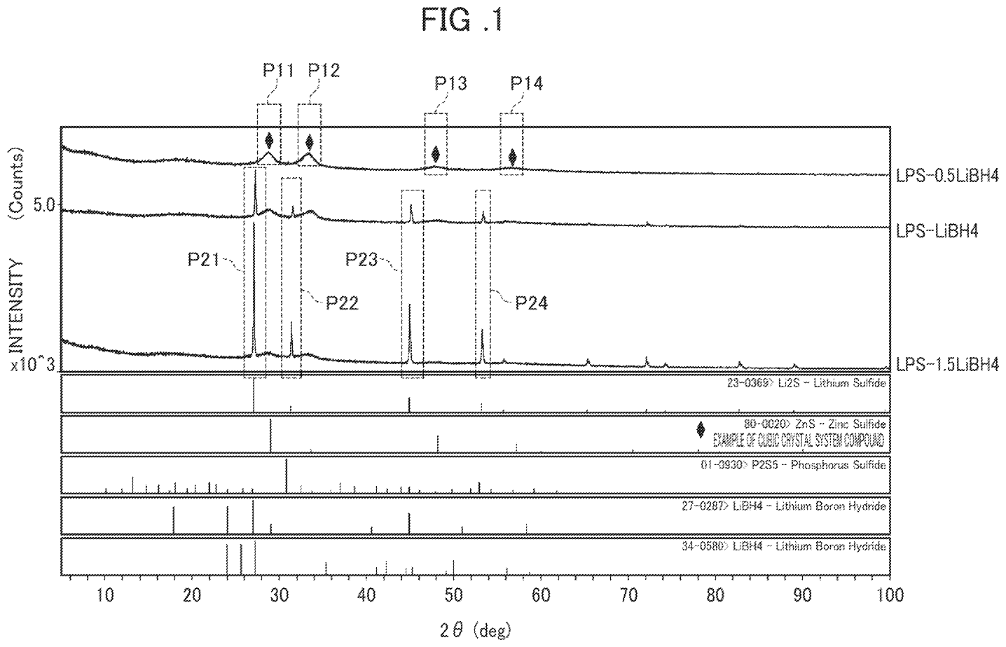

The crystalline structure of the sulfide-based solid electrolytes according to the above Examples and Comparative Examples were analyzed using XRD (“D8 Advance” manufactured by Bruker AXS, X-ray source). The obtained XRD spectra are shown in FIG. 1.

As shown in FIG. 1, in the sulfide-based solid electrolytes according to Comparative Examples 1 and 2, peaks attributed to the source materials (P21 to P24) are recognized. On the other hand, in the sulfide-based solid electrolyte according to Example 1, the peaks attributed to the above-mentioned source materials disappear, and unknown peaks (P11 to P14) which do not exist in the XRD database were newly recognized in the vicinity of 2θ[deg]=29, 33, 48 and 57, respectively. A new crystalline structure was thereby confirmed, and chemical bonds are presumed to form between Li₂S—P₂S₅ and LiBH₄.

### (Charge/Discharge Test)

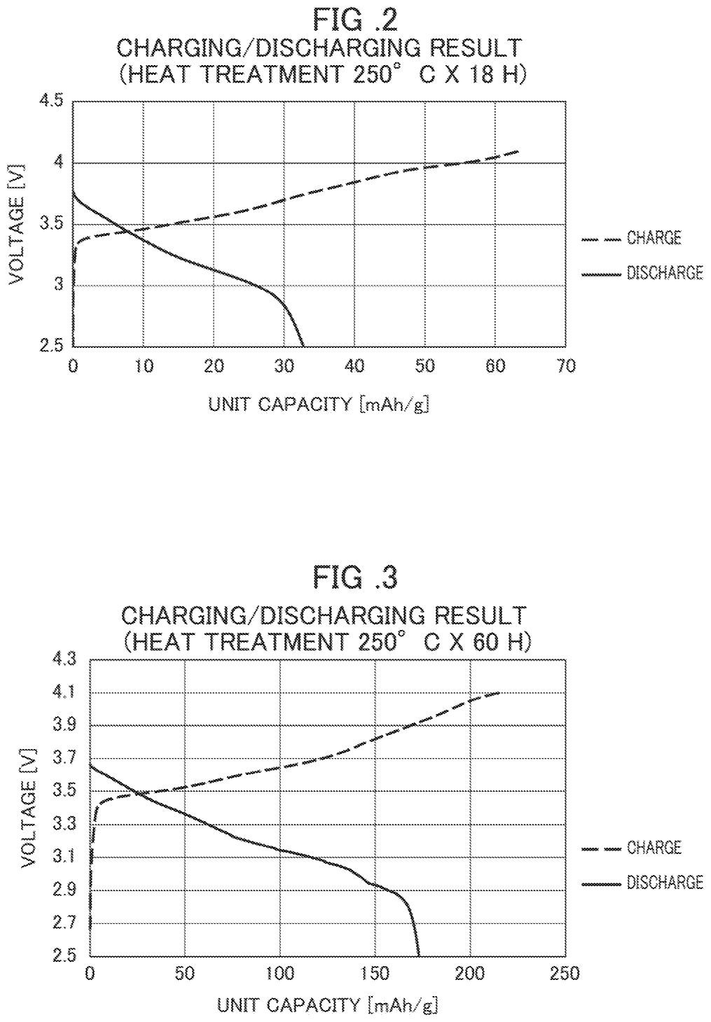

Using the sulfide-based solid electrolyte made by growing crystals with the heat treatment conditions of the sulfide-based solid electrolyte according to Example 1 of 250° C. and 18 hours as the solid electrolyte layer, the positive electrode layer was prepared with the positive electrode active material as NCM811 (LiNi_{0.8}Co_{0.1}Mn_{0.1}O₂), the solid-state battery cell was prepared with lithium-aluminum alloy as the negative electrode layer, and charge/discharge test was performed. The results are shown in FIG. 2. In addition, a solid-state battery cell was prepared similarly to above using the sulfide-based solid electrolyte made by growing crystals with the heat treatment conditions of 250° C. and 60 hours

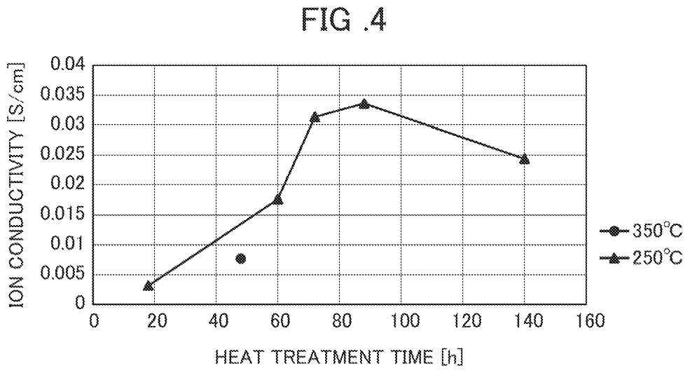

The results are shown in FIG. 3.

As shown in FIG. 2 and FIG. 3, in the solid-state secondary battery made using the sulfide-based solid electrolyte according to the present embodiment, it was confirmed that charge/discharge can be performed. In addition, by increasing the heat treatment time, it was confirmed that the charge capacity increased.

### (Ion Conductivity Measurement)

FIG. 4 is the measurement results of ion conductivity in the case of varying the heat treatment conditions of the sulfide-based solid electrolyte according to Example 1. AC impedance measurement was performed on a single solid electrolyte according to Example 1, and the ion conductivity was calculated from the obtained resistance value. From the results of FIG. 4, the result was confirmed in which the ion conductivity reaches a maximum in the case of setting the heat treatment temperature of 250° C. and heat treatment time of 88 hours.

### (LSV Measurement)

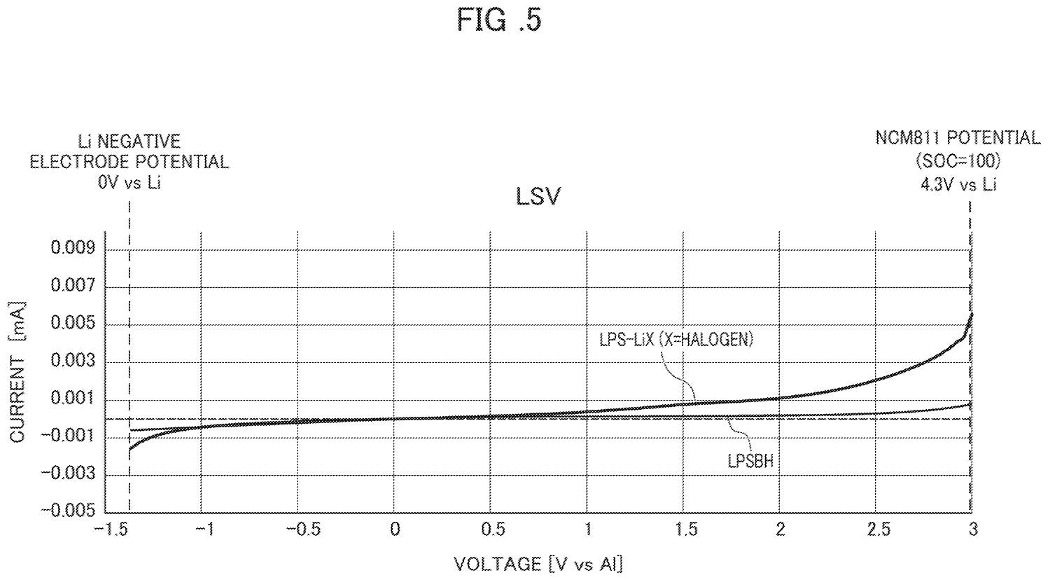

FIG. 5 is a graph showing the LSV measurement results of the solid-state secondary battery (LPSBH in FIG. 5) using the sulfide-based solid electrolyte according to Example 1 as the solid electrolyte layer, preparing the positive electrode layer with the positive electrode active material as NCM811, and prepared using lithium metal as the negative electrode layer. The LSV measurement conditions of FIG. 5 were swept at 5 mV/s from the standard potential at full charge of NCM811 until the standard potential of the lithium metal. In addition, except for using a commercially available sulfide-based solid electrolyte (LPS-LiX, X: halogen in FIG. 5), the solid-state secondary battery was prepared similarly to the above, and LSV measurement was performed at the same conditions as above. In the graph of FIG. 5, the horizontal axis indicates the potential (V), and the vertical axis indicates the current (mA).

As shown in FIG. 5, the solid-state secondary battery made using the sulfide-based solid electrolyte according to Example 1 caused almost no oxidation reaction and reduction reaction compared to the solid-state secondary battery made using the conventional sulfide-based solid electrolyte, and results superior in oxidation resistance and reduction resistance were confirmed.

### (Resistance Deterioration Measurement)

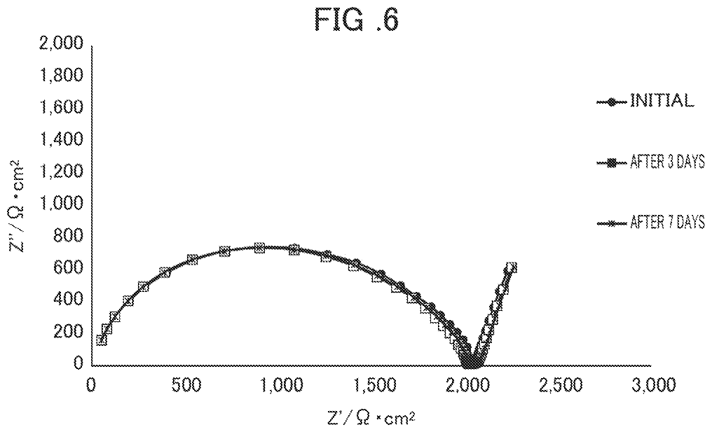

The solid-state secondary battery was prepared using the solid electrolyte shown in FIG. 5, and the resistance value was measured by the AC impedance method. Subsequently, after leaving for 3 days and 7 days, respectively in a state of full charge, the resistance value was measured by AC impedance method similarly. The results are shown in FIG. 6. As shown in FIG. 6, in the solid-state secondary battery produced using the sulfide-based solid electrode according to Example 1 the resistance value did not increase even after leaving for 7 days at full charge, and results in which preferable durability is obtained was confirmed. In contrast, when the resistance value was measured by the AC impedance method similarly using the conventional argyrodite-type sulfide-based solid electrolyte, the results were confirmed in which the resistance value after leaving for 7 days at full charge increased 12 times relative to the initial resistance value, and the resistance value after leaving for 14 days at full charge increased 23 times relative to the initial resistance value.

What is claimed is:

1. A sulfide-based solid electrolyte comprising:
a chemical bond formed between Li₂S—P₂S₅ and LiBH₄,
wherein a mole ratio of the Li₂S—P₂S₅ and the LiBH₄ is 1:0.5.

2. A solid-state secondary battery comprising a laminate body wherein a positive electrode layer, solid electrolyte layer and negative electrode layer are laminated,
wherein at least any of the positive electrode layer, the solid electrolyte layer and the negative electrode layer has the sulfide-based solid electrolyte according to claim 1, and
wherein the negative electrode layer has a lithium metal layer.

3. A method of manufacturing the sulfide-based solid electrolyte according to claim 1, comprising
a step of preparing by a liquid phase method so that a mole ratio of Li₂S, P₂S₅ and LiBH₄ becomes 6:2:3.
